(19) United States
(12) Patent Application Publication
(10) Pub. No.: US 2008/0244574 A1
(43) Pub. Date: Oct. 2, 2008

(54) Dynamically relocating devices between virtual machines

(76) Inventors: Vedvyas Shanbhogue, Portland, OR (US); Madhukar Tallam, Fremont, CA (US)

Correspondence Address: TROP PRUNER & HU, PC, 1616 S. VOSS ROAD, SUITE 750, HOUSTON, TX, 77057-2631, US

(21) Appl. No.: 11/728,429

(22) Filed: Mar. 26, 2007

(51) Int. Cl. G06F 9/455

(52) U.S. Cl. 718/1

(57) ABSTRACT

A virtual machine monitor may reassign hardware bus devices from one virtual machine to another. The virtual machine monitor may turn a device off, reassign it to a different virtual machine, and then turn the device back on. Device interrupts are remapped from the source virtual machine to the target virtual machine.

### BACKGROUND

This relates generally to computer systems and, particularly, to virtual machines.

In a virtual machine system, a virtual machine monitor has control over various operations and events occurring in the system. The virtual machine monitor may coordinate operation of virtual machines for protection from and between virtual machines. To this end, the virtual machine monitor typically receives control when the guest software accesses certain hardware resources or certain events occur, such as an interrupt or exception.

In some cases, the virtual machine monitor must coordinate between different virtual machines which seek to access different hardware devices. Thus, the virtual machine monitor may be required to handle the situation where two virtual machines seek to access the same device.

### BRIEF DESCRIPTION OF THE DRAWINGS

FIG. 1 is a schematic depiction of one embodiment of the present invention; and

FIG. 2 is a flow diagram for one embodiment of the present invention.

### DETAILED DESCRIPTION

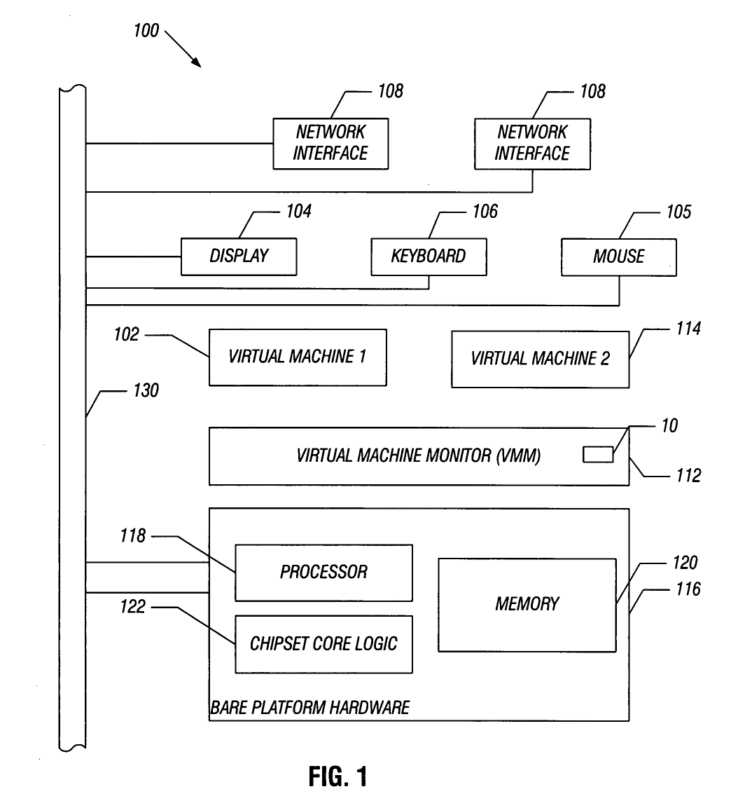

Referring to FIG. 1, a virtual machine environment 100 includes a bare platform hardware 116. The hardware 116 may comprise a computing platform that may be capable, for example, of executing a standard operating system or a virtual machine monitor, such as a virtual machine monitor (VMM) 112.

The virtual machine monitor 112, though typically implemented in software, may emulate and export a bare machine interface to higher level software. Such higher level software may comprise a standard or real time operating system, may be a highly stripped down operating environment with limited operating system functionality or may not include a traditional operating system facility. Alternatively, for example, the virtual machine monitor 112 may by run within, or on top of, another virtual machine monitor. Virtual machine monitors may be implemented, for example, in hardware, software, firmware, or by a combination of these techniques.

The platform hardware 116 may be a personal computer, a main frame, a handheld device, a personal computer, a set top box, or any other computing system. The platform hardware 116 includes a processor 118, a memory 120, and a chipset core logic 122.

The processor 118 may be any type of processor capable of executing software, such as a microprocessor, digital signal processor, microcontroller, or the like. The processor 118 may include microcode, programmable logic, or hard coded logic for execution. Though FIG. 1 shows only one such processor, there may be multiple processors in the system.

The memory 120 may be a hard disk, a floppy disk, a random access memory, a read only memory, a flash memory, or any combination of the above devices or any other type of machine readable medium. The memory 120 may store instructions and/or data for performing the execution of various embodiments.

The virtual machine monitor 112 presents to other software the abstraction of one or more virtual machines 102 and 114 which may provide the same or different abstractions to various guests. Each of the guests may expect to access physical resources, such as the processor registers, memory and input/output devices within the virtual machines 102 and 114.

The system may be associated with a plurality of hardware devices coupled to the bare platform hardware 116 by a bus 130 such as a Peripheral Component Interconnect (PCI) bus. See PCI Express Base 2.0 Specification available from the PCI Special Interest Group, Beaverton, Oreg. 97006. Those hardware devices may, for example, include network interfaces 108, display 104, keyboard 106, or mouse 105, to mention just a few typical examples.

In accordance with some embodiments, a mechanism may carry out dynamic reassignment of devices to virtual machines. With this scheme, the virtual machine owning a device has direct access to the hardware and incurs no performance penalty. When the device needs to be used by another virtual machine, the virtual machine monitor 112 revokes the hardware device from the virtual machine 102 or 114 currently using the device and makes it available to a new virtual machine.

An assign device hypercall may be used to achieve the dynamic reassignment of devices to a virtual machine. The hypercall performs a privileged operation and, thus, is made available only to certain privileged and trusted virtual machines within the system.

The assign device hypercall takes the identification of the device, such as the bus/device/function number of the device, and the identifier of the target virtual machine to which the device should be connected. Devices can include, as examples, any of the devices such as the network interfaces 108, the display 104, the keyboard 106, or the mouse 105.

Upon the assign device hypercall being invoked, the virtual machine monitor 112 locates a PCI configuration space of the device being requested for reassignment. It powers the device off. Then the device is remapped into the target virtual machine's space. Remap tables are reprogrammed for this device to add it to the remap tables of the target virtual machine. The device interrupts are remapped to be routed to the target virtual machine.

In some embodiments, this arrangement allows pass through access to devices from the virtual machine. It does not require a para-virtualization of drivers. The drivers for the device of the two virtual machines are unrelated and do not need to be feature by feature on a par with each other.

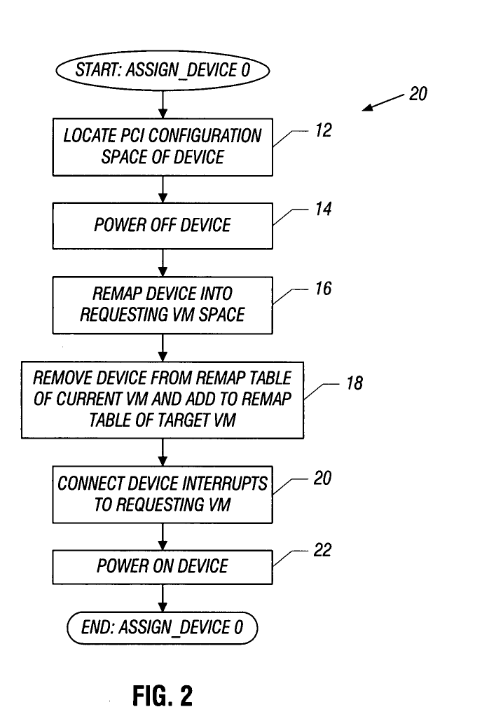

Referring to FIG. 2, in accordance with one embodiment, the virtual machine monitor 112 may implement the assigned device scheme 10. The assigned device scheme 10 may be implemented by software, hardware, or firmware, to mention a few examples. If implemented in software, it may be part of the monitor 112 and may be stored in computer readable form in the memory 120 (FIG. 1).

Initially, at block 12, the PCI configuration space of a device to be reassigned is identified and located. Then the device may be powered off (block 14), for example, by placing the device in a D3 Advanced Configuration and Power Interface (ACPI) state. See ACPI Specification 3.0, Sep. 2, 2004. Then, the device is remapped by the virtual machine monitor into the requesting virtual machine space as indicated at 16. At the same time, the device may be removed from the remap table of the current virtual machine and added to the remap table of the target virtual machine as indicated in block 18.

Next, the device interrupts are connected to the correct (new) virtual machine as indicated in block 20, and the device is powered on as indicated in block 22. In one embodiment, the device may be powered on by placing it in the ACPI DO state.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A computer readable medium storing instructions: to enable a computer to:
enable a virtual machine monitor to assign a bus device to a source virtual machine;
enable the virtual machine monitor to reassign a device from the source virtual machine to a target virtual machine; and
remap device interrupts to the target virtual machine.

2. The medium of claim 1 further storing instructions to locate the configuration space of said bus device.

3. The medium of claim 2 further storing instructions to remove the device from a table of the source virtual machine.

4. The medium of claim 3 further storing instructions to enable the virtual machine monitor to turn a device off.

5. The medium of claim 4 further storing instructions to enable the virtual machine monitor to reassign the device to the target virtual machine and then turn the device back on.

6. The medium of claim 5 further storing instructions to add a bus device to a remap table for the target virtual machine.

7. A system comprising:
a processor; and
a virtual machine monitor coupled to the processor, said virtual machine monitor to assign a bus device to a source virtual machine, to reassign the device from the source virtual machine to a target virtual machine and to remap device interrupts to the target virtual machine.

8. The system of claim 7, said virtual machine monitor to locate the configuration space of said bus device.

9. The system of claim 8, said virtual machine monitor to remove the device from a table of the source virtual machine.

10. The system of claim 9, said virtual machine monitor to turn the bus device off.

11. The system of claim 10, said virtual machine monitor to reassign the device to the target machine and then turn the device back on.

12. The system of claim 11, said virtual machine monitor to add a bus device to a remap table for the target virtual machine.
